(19) United States
(12) Patent Application Publication
(10) Pub. No.: US 2026/0046914 A1
(43) Pub. Date: Feb. 12, 2026

(54) Electronic Devices, Methods, and Systems Providing Application Performance Enhancement Using Uplink Carrier Aggregation and Transmit Switching Times

(71) Applicant: Motorola Mobility LLC, Chicago, IL (US)

(72) Inventors: Armin W. Klomsdorf, Chicago, IL (US); Daniel C. Chisu, Franklin Park, IL (US); John Vitale, Chicago, IL (US)

(21) Appl. No.: 18/798,480

(22) Filed: Aug. 8, 2024

(51) Int. Cl. H04W 72/542; H04W 72/044; H04W 72/21

(52) U.S. Cl. CPC H04W 72/542; H04W 72/044; H04W 72/21

(57) ABSTRACT

An electronic device supports multiple uplink carrier aggregation (UL CA) combinations for various frequency bands. The device includes processors that predict whether a foreground application will be optimized by a high bandwidth UL CA combination, a low uplink transmit switching time UL CA combination, or a UL CA combination having both a higher bandwidth and a lower uplink transmit switching time. The processors select the appropriate UL CA combination and transmit this information to a remote device. The method involves ranking UL CA combinations based on throughput and latency scores, building a user equipment capability information (UCI) message with fewer UL CA combinations, and dynamically updating the UCI message based on hardware changes or application requirements. This approach ensures optimal performance for applications requiring high throughput, low latency, or both.

### BACKGROUND

### Technical Field

This disclosure relates generally to electronic devices, and more particularly to electronic devices supporting wireless communication capabilities.

### Background Art

With devices supporting advanced communication technologies, a concept of uplink transmit switching has been employed to allow communication across multiple modalities, examples of which include carrier aggregation and multiple input-multiple output, thereby increasing overall bandwidth and bitrates. “Carrier aggregation” (CA), which is used in wireless celluar networks, increases bandwidth, thereby increasing bandwidth. As an example, in carrier aggregation each aggregated carrier can have a bandwidth of 1.4 MHz, 3 MHz, 5, MHz, 10 MHz, 15 MHz, or 20 MHz, and even up to 100 MHz. When aggregated across carriers, which are referred to as “component carriers” (CC), a maximum of five component carriers can offer extremely high maximum aggregated bandwidths.

Uplink transmit switching between carrier aggregation and multiple input-multiple output communication is defined in the specifications proffered by the Third Generation Partnership Project (3GPP). Uplink transmit switching allows a device to dynamically switch between different transmission modes, such as from an uplink multiple input multiple output mode to a lower frequency, frequency division duplex (FDD) band, time division duplex (TDD) bands in addition to FDD (as in device operating in mode FDD-NR 1Tx+TDD-NR 1Tx and uplink is being switched between TDD and FDD carriers), or a combination of these bands. However, switching transmit paths cannot be done instantaneously as analog and digital circuits must be put into a ready state or reconfigured before switching can occur. It would be advantageous to have improved methods and systems for user equipment that allowed for application performance optimization when switching occurs.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory method in accordance with one or more embodiments of the disclosure.

FIG. 3 illustrates one or more method steps in accordance with one or more embodiments of the disclosure.

FIG. 4 illustrates explanatory ranking results for uplink carrier aggregation (UL CA) combinations in accordance with one or more embodiments of the disclosure.

FIG. 5 illustrates one explanatory user equipment capability information (UCI) message in accordance with one or more embodiments of the disclosure.

FIG. 6 illustrates another explanatory method in accordance with one or more embodiments of the disclosure.

FIG. 7 illustrates one or more method steps in accordance with one or more embodiments of the disclosure.

FIG. 8 illustrates embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to predicting, by one or more processors of an electronic device, which is referred to sometimes as “user equipment” or “UE,” whether a foreground application to be initiated for operation on one or more processors of the electronic device will be better optimized when served by at least one high bandwidth UL CA combination, at least one low uplink transmit switching time UL CA combination, or at least one combined UL CA combination that blends high bandwidth and low switching times to determine a predicted UL CA combination, and then transmitting the predicted UL CA combination to a remote electronic device across a network that is serving the electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of predicting whether a first application that is optimized when a communication device of the electronic device supports a high bandwidth UL CA combination, a second application that is optimized when the communication device supports a low latency UL CA combination, or a third application optimized when the communication device supports a combined higher bandwidth and lower latency UL CA combination and causing the communication device to identify the predicted UL CA combination to the network as described herein. The non-processor circuits may include, but are not limited to, a radio receiver, a radio transmitter, signal drivers, clock circuits, power source circuits, and user input devices.

As such, these functions may be interpreted as steps of a method to perform assigning, by one or more processors, a bandwidth score to a plurality of UL CA combinations supported by a communication device of the electronic device while also assigning, by the one or more processors, a latency score to the plurality of UL CA combinations, combining, by the one or more processors, the bandwidth score and the latency score of each UL CA combination of the plurality of UL CA combinations, predicting, by the one or more processors, a predicted application to be launched for operation on the one or more processors, and selecting one of at least one UL CA combination having a high bandwidth score, at least one UL CA combination having a low latency score, or at least one UL CA combination having a combined bandwidth and latency score indicating high bandwidth and low latency as a function of the predicted application as a selected UL CA combination. In one or more embodiments, the method can further comprise causing, by the one or more processors, the communication device to transmit a user equipment capability information (UCI) message identifying the selected UL CA combination across a network to a remote electronic device.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on. ” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, with devices supporting advanced communication technologies, a concept of uplink transmit switching is required as defined in the 3GPP specifications. Uplink transmit switching allows a device to dynamically switch between different transmission modes. Illustrating by example, a device can switch from an uplink multiple input multiple output mode to a typically lower FDD frequency band. With transmit switching, the device can also use a combination of these bands in a UL CA pairing.

Switching transmit paths cannot be done instantaneously as analog and digital circuits are put into a ready state or reconfigured. Instead, the user equipment reports to the network the transmit switching times for different band combinations such that the network can assign the radio configuration for the connection accordingly. The reporting is performed via a capability information message which is built statically based on the radio frequency hardware support.

The transmit switching times depend on radio frequency (RF) architecture and band combinations, which take into account the RF band used. Some combinations take as little as thirty-five microseconds for the transmit path to switch from one frequency to another, while others can take longer times, such as 140 or 250 microseconds. The higher the switching time, the higher the latency. The latency will be obtained when using a combination with the switching time. Regarding throughput, the higher the aggregate bandwidth, the higher the resulting throughput will be.

Embodiments of the disclosure contemplate that the problem with the concept of uplink transmit switching as defined in the 3GPP specifications is that different UL CA combinations provide different latency or throughput performance. Embodiments of the disclosure contemplate that there is no knowledge from the network side regarding what applications are operating on the user equipment. Nor is there knowledge at the network side as to which UL CA combination would best optimize the user experience based upon the application being used by a user.

With the concept of uplink transmit switching as defined in the 3GPP specifications, the network assigns to user equipment a particular UL CA combination regardless of whether the application operating on the user equipment has uplink throughput or latency critical requirements. Indeed, with the concept of uplink transmit switching as defined in the 3GPP specifications there is no consideration of the transmit switching times or uplink bandwidth when the UL CA combination is assigned. Embodiments of the disclosure contemplate that as new uplink intensive applications emerge, there will soon be an unprecedented increase in uplink wireless data traffic. However, current network designs in accordance with the concept of uplink transmit switching as defined in the 3GPP specifications are prioritized on optimizing the downlink performance. Thus, prior art uplink transmit switching concepts do not always consider or prioritize uplink communications.

Advantageously, embodiments of the disclosure provide a solution to this problem. In one or more embodiments, a method and mechanism on the user equipment is provided that predicts that a data connection will be required for an application and further determines the uplink performance criteria of the application in terms of throughput, latency, or both. The method then determines the UL CA combinations that the device supports based on dynamic hardware capability, offering the uplink throughput and uplink latency by using uplink transmit switching times and the aggregate uplink bandwidths.

In one or more embodiments, the method assigns preference scores to each combination ranging from low to high. In one or more embodiments, a UL CA combination with a low transmit switching time will be preferred for latency-intensive applications, while a combination with the aggregate uplink bandwidth will be preferred for uplink throughput-intensive applications. In one or more embodiments, a total weight of the two categories is summed up for applications that require both criteria. In one or more embodiments, the output of this evaluation is three lists of UL CA combinations, one most suitable for UL throughput, one for UL latency, and one for both.

In one or more embodiments, a method in an electronic device involves selecting, by one or more processors, from a plurality of UL CA combinations supported by a communication device of the electronic device having multiple input and multiple output (MIMO) and carrier aggregation (CA) communication modes of operation. In one or more embodiments, the method includes selecting at least one high bandwidth UL CA combination, at least one low uplink transmit switching time UL CA combination, and at least one combined UL CA combination having a higher bandwidth and a lower uplink transmit switching time associated therewith than at least one other UL CA combination of the plurality of UL CA combinations.

In one or more embodiments, the method further involves predicting, by the one or more processors, whether a foreground application to be initiated for operation on the one or more processors will be better optimized when served by the at least one high bandwidth UL CA combination, the at least one low uplink transmit switching time UL CA combination, or the at least one combined UL CA combination to determine a predicted UL CA combination. In one or more embodiments, the method also includes causing, by the one or more processors, the communication device to transmit the predicted UL CA combination to a remote electronic device of a network serving the communication device of the electronic device.

Advantageously, this method allows the electronic device to dynamically select the most appropriate UL CA combination based on the predicted requirements of a foreground application. This ensures that the device can optimize its performance for either high throughput, low latency, or a combination of both, depending on the application's needs. By doing so, the device can provide a better user experience by minimizing latency for latency-sensitive applications or maximizing throughput for data-intensive applications.

By predicting the application's requirements and selecting the optimal UL CA combination before the application is launched, the method reduces the need for subsequent reconfigurations of the UL CA combination. This preemptive selection process helps in avoiding unnecessary delays and ensures that the application can operate efficiently from the moment it is initiated.

The method involves transmitting the predicted UL CA combination to a remote electronic device (e.g., a network server), which allows the network to assign the optimal UL CA combination to the device. This communication ensures that the network is aware of the device's capabilities and the application's requirements, leading to more efficient resource allocation and improved overall network performance.

By incorporating both high bandwidth and low uplink transmit switching time considerations, the method provides a balanced approach to optimizing both throughput and latency. This dual consideration is particularly beneficial for applications that require both high data rates and low latency, such as real-time video streaming or interactive gaming.

In one or more embodiments, an electronic device comprises a communication device supporting a plurality of uplink carrier aggregation (UL CA) combinations for multiple frequency bands of operation. In one or more embodiments, the electronic device includes one or more processors operable with the communication device and a memory operable with the one or more processors.

In one or more embodiments, the memory stores at least a first application, a second application, and a third application. The first application operates on the one or more processors and is optimized when the communication device supports a high bandwidth UL CA combination. The second application operates on the one or more processors and is optimized when the communication device supports a low latency UL CA combination. The third application operates on the one or more processors and is optimized when the communication device supports a combined higher bandwidth and lower latency UL CA combination.

In one or more embodiments, the one or more processors predict whether the first application, the second application, or the third application will be initiated for operation. In one or more embodiments, the one or more processors cause the communication device to identify the high bandwidth UL CA combination to a network in communication with the communication device when the one or more processors predict the first application will be initiated for operation on the one or more processors.

In one or more embodiments, the one or more processors identify the low latency UL CA combination to the network when the one or more processors predict the second application will be initiated for operation on the one or more processors. In one or more embodiments, the one or more processors identify the combined higher bandwidth and lower latency UL CA combination when the one or more processors predict the third application will be initiated for operation on the one or more processors.

In one or more embodiments, the one or more processors cause the communication device to identify the high bandwidth UL CA combination in response to either a communication device hardware configuration change or the communication device operating in a RRC IDLE state. Advantageously, this ensures that the communication device dynamically adapts to the optimal UL CA combination based on the predicted application requirements and current hardware capabilities, thereby enhancing the overall performance and user experience.

Advantageously, by predicting whether the first application, the second application, or the third application will be initiated for operation, the one or more processors can dynamically adapt the communication device's UL CA combination to optimize performance based on the specific needs of the application. This ensures that the device can provide the best possible user experience by selecting the most appropriate UL CA combination for high bandwidth, low latency, or a combination of both, depending on the application's requirements.

When the one or more processors predict that the first application, which is optimized for high bandwidth, will be initiated, the communication device identifies and communicates the high bandwidth UL CA combination to the network. This allows the network to allocate resources that maximize throughput, ensuring efficient data transfer for bandwidth-intensive applications.

Similarly, when the second application, which is optimized for low latency, is predicted to be initiated, the communication device identifies and communicates the low latency UL CA combination to the network. This enables the network to allocate resources that minimize latency, providing a responsive experience for latency-sensitive applications.

For the third application, which requires both high bandwidth and low latency, the communication device identifies and communicates the combined higher bandwidth and lower latency UL CA combination. This balanced approach ensures that the application receives the necessary resources to perform optimally, addressing both throughput and latency requirements.

By dynamically adapting to the predicted application requirements and current hardware capabilities, the communication device can enhance overall performance and user experience. This method reduces the need for subsequent reconfigurations of the UL CA combination, avoiding unnecessary delays and ensuring efficient operation from the moment the application is initiated.

In one or more embodiments, a method in an electronic device that involves assigning, by one or more processors, a bandwidth score to a plurality of UL CA combinations supported by a communication device of the electronic device. In one or more embodiments, the method also includes assigning, by the one or more processors, a latency score to the plurality of UL CA combinations.

In one or more embodiments, the method further involves combining, by the one or more processors, the bandwidth score and the latency score of each UL CA combination of the plurality of UL CA combinations. In one or more embodiments, the method includes predicting, by the one or more processors, a predicted application to be launched for operation on the one or more processors.

In one or more embodiments, the method involves selecting one of at least one UL CA combination having a high bandwidth score, at least one UL CA combination having a low latency score, or at least one UL CA combination having a combined bandwidth and latency score indicating high bandwidth and low latency as a function of the predicted application as a selected UL CA combination. In one or more embodiments, the method also includes causing, by the one or more processors, the communication device to transmit a UCI message identifying the selected UL CA combination across a network to a remote electronic device.

Advantageously, this method ensures that the electronic device dynamically adapts the uplink carrier aggregation configuration based on the predicted requirements of the application to be launched. By assigning bandwidth and latency scores to each UL CA combination, the method allows for a comprehensive evaluation of the available combinations. The combination of these scores provides a balanced approach to selecting the optimal UL CA combination that meets the specific needs of the predicted application. This preemptive selection process helps in avoiding unnecessary delays and ensures efficient operation from the moment the application is initiated.

Additionally, the method involves transmitting a UCI message that identifies the selected UL CA combination to a remote electronic device, such as a network server. This communication ensures that the network is aware of the device's capabilities and the application's requirements, leading to more efficient resource allocation and improved overall network performance. By omitting at least some UL CA combinations from the plurality of UL CA combinations in the UCI message, the method reduces the size of the UCI message, thereby minimizing the signaling overhead and enhancing the efficiency of the communication process.

Since the method involves building a UCI message that includes the UL CA combinations that provide performance for the predicted application, with that UCI message being then transmitted to the network, the method advantageously enables the network to assign the optimal UL CA combination to the device based on the application's requirements. By doing so, the method reduces the need for subsequent reconfigurations and ensures efficient operation from the moment the application is initiated. Additionally, the method dynamically updates the UCI message if the hardware support changes, such as after an over-the-air (OTA) update, ensuring that the device operates with the most suitable UL CA combinations.

Another advantage offered by the method is the use of application and context-level feedback to drive the uplink optimization process. The method predicts the need for an optimized connection while the device is in an idle state and determines the level of uplink performance required by the application. This prediction can be based on monitoring user interactions, gestures, sensors, or other indicators that suggest the user may use a data-intensive application. This approach ensures that the device can preemptively select the optimal UL CA combination, providing a better user experience by minimizing latency for latency-sensitive applications or maximizing throughput for data-intensive applications.

Other advantages offered by embodiments of the disclosure will be described below. Still others will be obvious to those of ordinary skill in the art having the benefit of this disclosure.

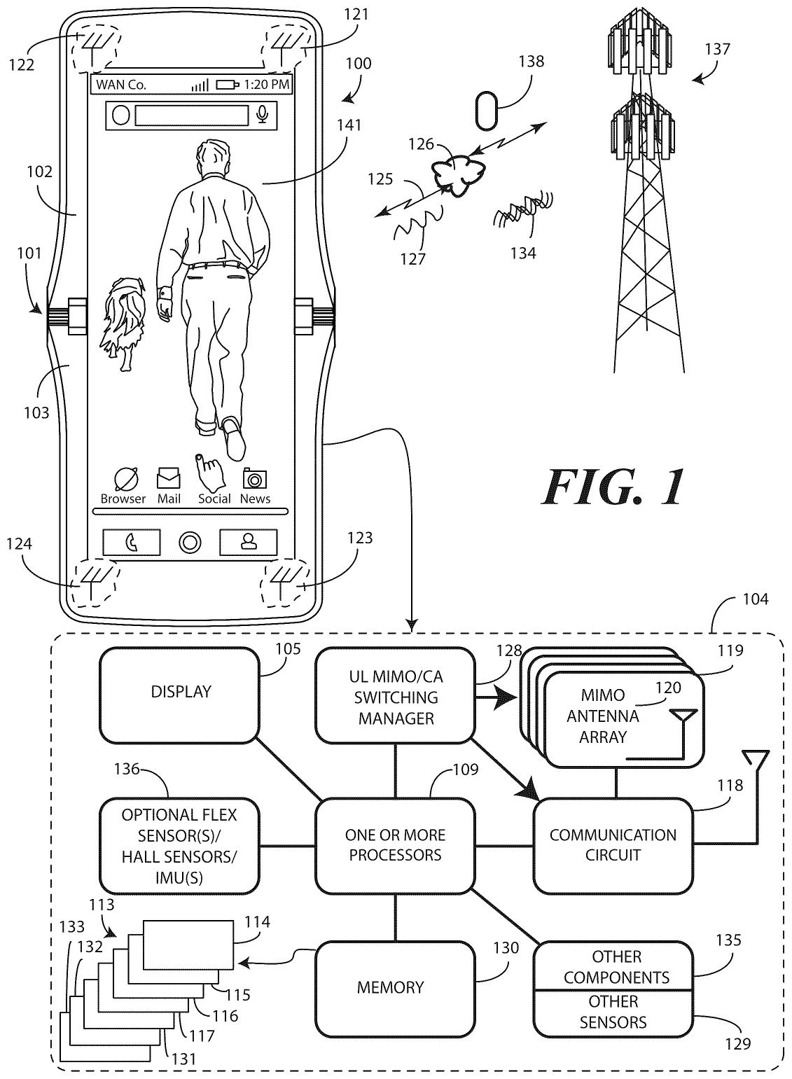

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, multimedia players, and so forth. Still other types of electronic devices can be configured in accordance with one or more embodiments of the disclosure as will be readily appreciated by those of ordinary skill in the art having the benefit of this disclosure.

The electronic device 100 includes a first device housing 102 and a second device housing 103. In one or more embodiments, a hinge assembly 101 couples the first device housing 102 to the second device housing 103.

In one or more embodiments, the first device housing 102 is selectively pivotable about the hinge assembly 101 relative to the second device housing 103. For example, in one or more embodiments the first device housing 102 is selectively pivotable about the hinge assembly 101 between a closed position and an axially displaced open position, which is shown in FIG. 1.

In other embodiments the electronic device 100 will include no hinge assembly 101, and instead will include a single device housing. While the electronic device 100 of FIG. 1 is a “clamshell” device, when the electronic device includes a single device housing, it is sometimes referred to as a “candy bar” device. Other mechanical configurations for the device housing will be obvious to those of ordinary skill in the art having the benefit of this disclosure.

In one or more embodiments the first device housing 102 and the second device housing 103 are manufactured from a rigid material such as a rigid thermoplastic, metal, or composite material, although other materials can be used. Still other constructs will be obvious to those of ordinary skill in the art having the benefit of this disclosure. In the illustrative embodiment of FIG. 1, the electronic device 100 includes a single hinge assembly. However, in other embodiments two or more hinges can be incorporated into the electronic device 100 to allow it to be folded in multiple locations.

This illustrative electronic device 100 of FIG. 1 includes a display 105. The display 105 can optionally be touch-sensitive. In one embodiment where the display 105 is touch-sensitive, the display 105 can serve as a primary user interface of the electronic device 100. Users can deliver user input to the display 105 of such an embodiment by delivering touch input from a finger, stylus, or other objects disposed proximately with the display 105.

In one embodiment, the display 105 is configured as an organic light emitting diode (OLED) display fabricated on a flexible plastic substrate, thereby making the display 105 a flexible display 141. This allows the display 105 to be flexible so as to deform when the first device housing 102 pivots about the hinge assembly 101 relative to the second device housing 103. In one or more embodiments, the OLED display is constructed on flexible plastic substrates can allow the flexible display 141 to bend with various bending radii.

In one or more embodiments the flexible display 141 may be formed from multiple layers of flexible material such as flexible sheets of polymer or other materials. In this illustrative embodiment, the flexible display 141 is fixedly coupled to the first device housing 102 and the second device housing 103. The flexible display 141 spans the hinge assembly 101 in this illustrative embodiment.

Features can be incorporated into the first device housing 102 and/or the second device housing 103. Examples of such features include an imager or an optional speaker port, which are disposed on the rear side of the electronic device 100 in this embodiment but could be placed on the front side as well.

In this illustrative embodiment, a user interface component, which may be a button or touch sensitive surface, can also be disposed along the rear side of the first device housing 102. As noted, any of these features are shown being disposed on the rear side of the electronic device 100 in this embodiment, but could be located elsewhere, such as on the front side in other embodiments. In other embodiments, these features may be omitted. Other features can be added and can be located on the front of one or both of the first device housing 102 and/or the second device housing 103, sides of one or both of the first device housing 102 and/or the second device housing 103, or in other locations as well.

A block diagram schematic 104 of the electronic device 100 is also shown in FIG. 1. In one or more embodiments, the block diagram schematic 104 can be configured as a printed circuit board assembly disposed within either or both of the first device housing 102 or the second device housing 103 of the electronic device 100.

Various components can be electrically coupled together by conductors or a bus disposed along one or more printed circuit boards. For example, some components of the block diagram schematic 104 can be configured as a first electronic circuit fixedly situated within the first device housing 102, while other components of the block diagram schematic 104 can be configured as a second electronic circuit fixedly situated within the second device housing 103. A flexible substrate can then span the hinge assembly 101 to electrically couple the first electronic circuit to the second electronic circuit.

It should be noted that the block diagram schematic 104 includes many components that are optional, but which are included in an effort to demonstrate how varied electronic devices configured in accordance with embodiments of the disclosure can be. Thus, it is to be understood that the block diagram schematic 104 of FIG. 1 is provided for illustrative purposes only and for illustrating components of one electronic device 100 in accordance with embodiments of the disclosure. The block diagram schematic 104 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components, and still be within the scope of the present disclosure.

In one or more embodiments, the electronic device 100 includes one or more processors 109. The one or more processors 109 can be a microprocessor, a group of processing components, one or more Application Specific Integrated Circuits (ASICs), programmable logic, or other type of processing device. The one or more processors 109 can be operable with the various components of the electronic device 100. The one or more processors 109 can be configured to process and execute executable software code to perform the various functions of the electronic device 100. A storage device, such as memory 130, can optionally store the executable software code used by the one or more processors 109 during operation.

In one or more embodiments, the one or more processors 109 are further responsible for performing the primary functions of the electronic device 100. For example, in one embodiment the one or more processors 109 comprise one or more circuits operable to present presentation information, such as images, text, and video, on the flexible display 141. The executable software code used by the one or more processors 109 can be configured as one or more modules 113 that are operable with the one or more processors 109. Such modules 113 can store instructions, control algorithms, and so forth.

In one embodiment, the one or more processors 109 are responsible for running the operating system environment 114. The operating system environment 114 can include a kernel, one or more drivers 115, and an application service layer 116, and an application layer 117. The operating system environment 114 can be configured as executable code operating on one or more processors or control circuits of the electronic device 100.

In one or more embodiments, the one or more processors 109 are responsible for managing the applications of the electronic device 100. In one or more embodiments, the one or more processors 109 are also responsible for launching, monitoring and killing the various applications and the various application service modules. The applications of the application layer 117 can be configured as clients of the application service layer 116 to communicate with services through application program interfaces (APIs), messages, events, or other inter-process communication interfaces.

In this illustrative embodiment, the electronic device 100 also includes a communication circuit 118 that can be configured for wired or wireless communication with one or more other devices or networks. The networks can include a wide area network, a local area network, and/or personal area network. The communication circuit 118 may also utilize wireless technology for communication, such as, but are not limited to, peer-to-peer or ad hoc communications, and other forms of wireless communication such as infrared technology. The communication circuit 118 can include wireless communication circuitry, one of a receiver, a transmitter, or transceiver, and one or more antennas.

In the illustrative embodiment of FIG. 1, the one or more antennas comprise a MIMO antenna array 120 comprising a plurality of antennas 121,122,123,124 configured for MIMO communication 134 with other remote electronic devices, servers, base stations, and so forth, across a network 126. By including a MIMO antenna array 120, a transmit switching manager 128 is able to perform transmit switching to support both fifth generation of mobile communications (5G) UL CA communication 127 and 5G uplink MIMO communication 134 across a network 126.

Accordingly, in one or more embodiments the transmit switching manager 128 can perform uplink transmit switching 125 as required and defined in the 3GPP specifications. This allows the transmit switching manager 128 to dynamically switch between uplink MIMO (which is high throughput) and the typically lower frequency FDD band coverages. As noted above, a combination of these bands can be used in a UL CA pairing.

In the illustrative embodiment of FIG. 1, the MIMO antenna array 120 consists of four antennas 121,122,123,124, with a first antenna 121 being positioned in an upper righthand corner (as viewed in FIG. 1) of the first device housing 102 and a second antenna 122 being positioned in a left-hand corner of the first device housing 102. A third antenna 123 is positioned at the lower righthand corner of the second device housing 103, while a fourth antenna 124 is positioned at the lower left-hand corner of the second device housing 103.

While four antennas 121,122,123,124 are shown as defining the MIMO antenna array 120 in FIG. 1, it should be noted that embodiments of the disclosure, and in particular dynamic MIMO antenna array optimization techniques, are not limited to only MIMO antenna arrays having four antennas. While MIMO antenna arrays including four antennas are commonly utilized in electronic devices such as smartphones today, embodiments of the disclosure contemplate that soon electronic devices will be equipped with six antennas, eight antennas, or higher numbers of antennas defining MIMO antenna arrays in the future.

Accordingly, while a four-antenna element MIMO antenna array is used illustratively to explain how application performance improvement based upon UL CA and transmit switching times can work, it will be obvious to those of ordinary skill in the art having the benefit of this disclosure that these dynamic optimization techniques can equally be applied—and likely to produce additional benefits—in MIMO systems having more than six antenna elements.

The transmit switching manager 128 can be configured as a hardware module operable with the one or more processors 109 in one or more embodiments. In other embodiments, the transmit switching manager 128 is configured as software or firmware operating on the one or more processors 109. In still other embodiments, the transmit switching manager 128 is configured as a hardware component integrated within the one or more processors 109. Other configurations for the transmit switching manager 128 will be obvious to those of ordinary skill in the art having the benefit of this disclosure.

In one or more embodiments, the memory 130 stores at least a first application 131 operable on the one or more processors 119. In one or more embodiments, the first application 131 has a first application optimized operation when the communication device 118 supports a high bandwidth UL CA combination.

In one or more embodiments, the memory 130 stores at least a second application 132 operable on the one or more processors 119 having a second application optimized operation when the communication device supports a low latency UL CA combination. In one or more embodiments, the memory 130 stores at least a third application 133 operable on the one or more processors 119 having a third application optimized operation when the communication device supports a combined higher bandwidth and lower latency UL CA combination.

In one or more embodiments, the one or more processors 119 predict whether the first application 131, the second application 132, or the third application will be initiated for operation. In one or more embodiments, the transmit switching manager 128 causes the communication device 118 to identify the high bandwidth UL CA combination to a device 137 operating the network 126 in communication with the communication device 118 when the one or more processors 119 predict the first application 131 will be initiated for operation on the one or more processors 119. In one or more embodiments, the one or more processors 119 identify the low latency UL CA combination to the network 126 when the one or more processors 119 predict the second application 132 will be initiated for operation on the one or more processors. In one or more embodiments, the one or more processors 119 identify the combined higher bandwidth and lower latency UL CA combination when the third application 133 will be initiated for operation on the one or more processors 119.

In one or more embodiments, the one or more processors 119 cause the communication device 118 to identify the high bandwidth UL CA combination only at certain times. Illustrating by example, in one or more embodiments the one or more processors 119 cause the communication device 118 to identify the high bandwidth UL CA combination in response to a communication device hardware configuration change. In other embodiments, the one or more processors 119 cause the communication device 118 to identify the high bandwidth UL CA combination or the communication device operating in a RRC IDLE state.

By performing these operations, a method and mechanism is provided in the electronic device 100 to predict that a particular data connection will be required for a particular application. In one or more embodiments, the one or more processors 119 are configured to further determine the uplink performance criteria of the application in terms of throughput, latency, or both. In one or more embodiments, the one or more processors 119 then determine the UL CA combinations that are supported by the communication device 118 of the electronic device 100 based on dynamic hardware capability, offering the uplink throughput and uplink latency by using uplink transmit switching times and the aggregate uplink bandwidths.

In one or more embodiments, the one or more processors 119 assign preference scores to each combination ranging from low to high. Illustrating by example, a UL CA combination with a low transmit switching time will be preferred for latency-intensive applications in one or more embodiments. Similarly, a combination with the aggregate uplink bandwidth will be preferred for uplink throughput-intensive applications in one or more embodiments. In one or more embodiments, the one or more processors 119 sum a total weight of the two categories for applications that require both criteria.

In one or more embodiments, the output of this evaluation comprises three lists of UL CA combinations. A first list defines the supported UL CA combinations most suitable for UL throughput. The second list defines the UL CA combinations preferred as a function of latency. A third list defines the UL CA combinations best suited for both.

In one or more embodiments, a partial UCI message 138 is then built containing only the UL CA combinations that will provide the highest uplink throughput or uplink latency performance. In one or more embodiments, the communication device 118 transmits this partial UCI message 138 to the network 126, after which the electronic device 100 capability is updated with the network 126 such that the network 126 will assign the highest UL CA combination to the electronic device 100 based on the user's application requirements.

In one or more embodiments, this transmission of the partial UCI message 138 and corresponding assignment of the highest UL CA combination to the electronic device 100 is attempted whenever the electronic device 100 is in RRC-idle state. In some embodiments, this process occurs only when the hardware capability of the electronic device 100 changes, such as after an over-the-air update which enables new RF band support.

This specific timing of the process helps to ensure the subsequent RRC connection will provide the user with the most optimum UL CA combination. One particular advantage of these operations is that they also indirectly reduce large UCI message sizes, which is a known issue. In one or more embodiments, the data connection prediction involves predicting the application initiation intentions for upcoming data activity for highly demanding applications. Prediction may be based on monitoring user interaction with the application, gestures, cameras, sensors, or anything else which could indicate that the user may end up using a data-intensive app. This is specifically important for virtual reality and augmented reality applications. It is also important for and 5G millimeter-wave applications, where a prediction may be based on user context, such as about to put on augmented reality glasses or pairing them with the cellular module.

What is amazing about embodiments of the disclosure is that they provide for dynamically optimizing application performance on a mobile device by selecting the most suitable UL CA combinations based on the application's specific performance criteria, such as uplink throughput, latency, or both. Unlike existing systems where the network assigns UL CA combinations without considering the application's requirements, the electronic device 100 of FIG. 1 predicts the application's needs and selects UL CA combinations that best meet those needs.

In one or more embodiments, this selection process takes into account the device's dynamic hardware capabilities, including uplink transmit switching times and aggregate uplink bandwidths, and assigns preference scores to each combination. As noted, the one or more processors 109 can be configured to generates three lists of UL CA combinations: one optimized for uplink throughput, one for uplink latency, and one for both criteria.

Additionally, the electronic device 100 of FIG. 1 facilitates building a UCI message 138 that includes only the UL CA combinations that provide the best performance for the predicted application. Said differently, in one or more embodiments the UCI message 138 omits at least some UL CA combinations from the plurality of UL CA combinations that are provided to the network 126.

In one or more embodiments, this UCI message 138 is then transmitted to the network 126, enabling the network 126 to assign the optimal UL CA combination to the electronic device 100 based on the application's requirements. The one or more processors 109 can also dynamically update the UCI message 138 if the hardware support changes, such as after an over-the-air (OTA) update. Advantageously, this ensures that the electronic device 100 operates with the most suitable UL CA combinations.

Another novel feature of the electronic device 100 of FIG. 1 is the use of application and context-level feedback to drive the uplink optimization process, predicting the need for an optimized connection while the electronic device 100 is in an idle state and determining the level of uplink performance required by the application. This approach ensures that the electronic device 100 can preemptively select the optimal UL CA combination, providing a better user experience by minimizing latency for latency-sensitive applications or maximizing throughput for data-intensive applications.

The electronic device 100 can include one or more sensors 129. Illustrating by example, in one embodiment, the one or sensors 129 comprise one or more flex sensors 136, operable with the one or more processors 109, to detect a bending operation that causes the first device housing 102 to pivot about the hinge assembly 101 relative to the second device housing 103, thereby transforming the electronic device 100 into a deformed geometry. In one or more embodiments, the one or more flex sensors 136 can detect initiation of the first device housing 102 pivoting, bending, or deforming about the hinge assembly 101 relative to the second device housing 103.

Other components 135 of the electronic device 100 may include a microphone, an earpiece speaker, a loudspeaker, key selection sensors, a touch pad sensor, a touch screen sensor, a capacitive touch sensor, and one or more switches. Touch sensors may be used to indicate whether any of the user actuation targets present on the flexible display 141 are being actuated. Alternatively, touch sensors disposed along the first device housing 102 and/or the second device housing 103 can be used to determine whether the electronic device 100 is being touched at side edges or major faces of the electronic device 100 by a surface, hands, keys, or other objects. The touch sensors can include surface and/or housing capacitive sensors in one embodiment.

The other components 135 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration. ” A gyroscope can be used in a similar fashion. In one embodiment the motion detectors are also operable to detect movement, and direction of movement, of the electronic device 100 by a user.

In one or more embodiments, the other components 135 include a gravity detector. For example, as one or more accelerometers and/or gyroscopes may be used to show vertical orientation, constant, or a measurement of tilt relative to gravity. The other components 135 operable with the one or more processors 109 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

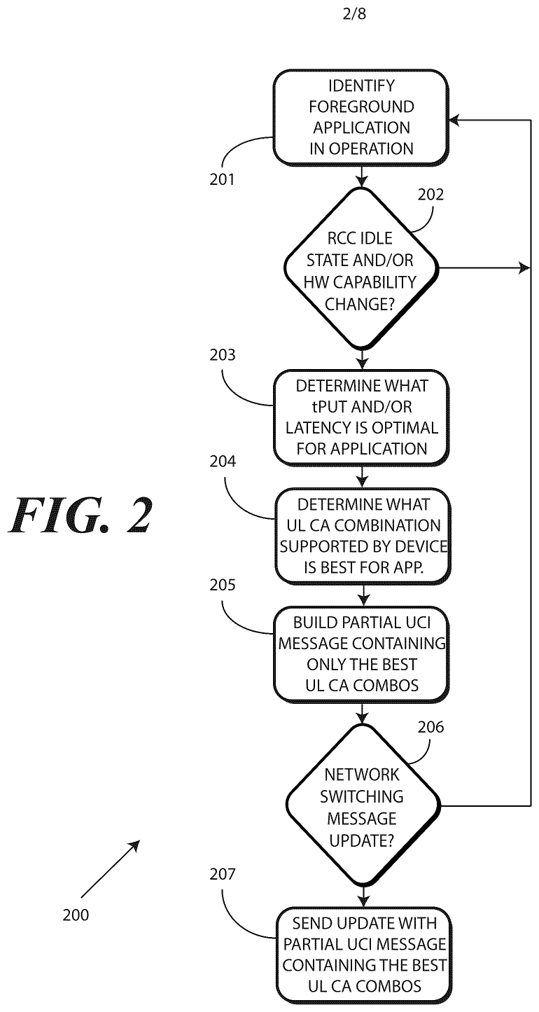

Turning now to FIG. 2, illustrated therein are one or more method steps illustrating how the components of the electronic device (100) of FIG. 1 can be used to perform application performance improvement based upon UL CA combination and transmit switching times. Beginning at step 201, one or more processors (109) of the electronic device (100) identify a foreground application that is, or will be, operating on the one or more processors (109). Step 201 can include either predicting a foreground application to be initiated for operation on the one or more processors (109) or, alternatively, detecting the foreground application operating on the one or more processors (109) after initiation.

In one or more embodiments, step 201 comprises predicting, by the one or more processors (109), which foreground application is likely to be initiated on the one or more processors (109). Illustrating by example, in one or more embodiments this predicting comprises monitoring, by the one or more sensors (129) user interactions with the electronic device (100).

Imagine, for example, that Armin, a dedicated options trader, relies heavily on his electronic device configured in accordance with embodiments of the disclosure to manage his option trades during his daily commute. Each morning, as Armin boards the train for his long ride to work, he launches his option trading application. This application, integral to his financial success, demands high bandwidth to ensure that he does not experience slippage, which could result in significant monetary losses. The application, while requiring minimal throughput, necessitates a robust and consistent bandwidth to handle the rapid data exchanges and real-time updates required for trading options.

Given this behavior, at step 201 the one or more processors (109) of Armin's device, equipped with advanced predictive capabilities, have learned his routine. Recognizing the importance of his trading activities, the one or more processors (109) predict that each time Armin is about to board the train, a high bandwidth UL CA combination is required. This prediction at step 201 is based on monitoring his daily patterns and interactions with the electronic device (100). As Armin approaches the train station, the one or more processors (109) of the electronic device (100) proactively identifies the need for a high bandwidth UL CA combination to ensure that Armin's device is allocated the optimal resources, providing a seamless and efficient trading experience.

While this is one illustrative example of how the prediction can occur, it will be obvious to those of ordinary skill in the art having the benefit of this disclosure that the prediction can occur in other ways as well. For instance, step 201 can comprise predicting the foreground application can comprise assessing, by the one or more processors (109), a log of previous foreground application operation initiations on the one or more processors (109). In other embodiments, the predicting the foreground application to be initiated for operation on the one or more processors (109) comprises assessing one or more of a time of day, calendar events stored within a calendaring application operating on the one or more processors (109), and/or a location of the electronic device (100) as determined by a location detector operable with the one or more processors (109).

Decision 202 then determines whether the electronic device (100) is in an RCC IDLE state or whether a hardware configuration change has occurred. In one or more embodiments, this decision 202 is made because transmission of a UCI message (138) at step 207 only occurs when the RRC state of the communication device (118) is in RRC IDLE state. In some embodiments, transmission of a UCI message (138) at step 207 only occurs when the RRC state of the communication device (118) is in RRC IDLE state and in response to the foreground application being initiated. In still other embodiments, transmission of a UCI message (138) at step 207 only occurs when a hardware capability change has occurred. Thus, in one or more embodiments where the electronic device (100) is in an RCC IDLE state or when a hardware configuration change has occurred, the method 200 moves to step 203. Otherwise, the method 200 returns to step 201 in one or more embodiments.

At step 203, the one or more processors (109) select, from a plurality of UL CA combinations supported by a communication device (118) of the electronic device (100) at least one high bandwidth UL CA combination, at least one low uplink transmit switching time UL CA combination, and at least one combined UL CA combination having a higher bandwidth and a lower uplink transmit switching time associated therewith than at least one other UL CA combination of the plurality of UL CA combinations. Embodiments of the disclosure contemplate that a higher bandwidth UL CA combination results in higher throughput data communication available to the foreground application detected at step 201, while a lower uplink transmit switching time CA combination results in lower data latency data communication available to the foreground application detected at step 201.

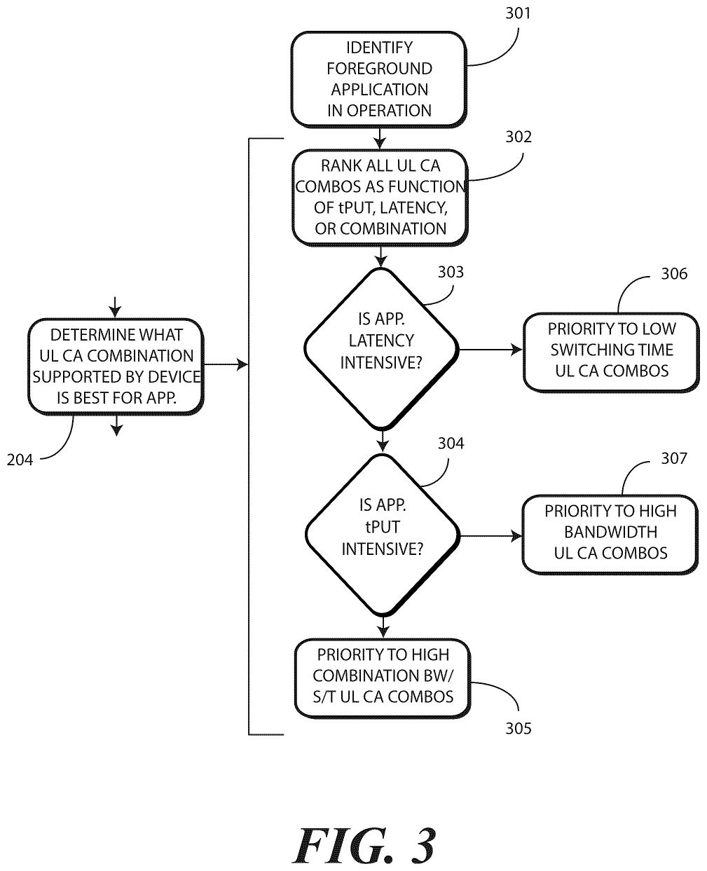

At step 204, the one or more processors (109) predict whether the foreground application identified at step 201 (whether predicted or actually operating) will be better optimized when served by the at least one high bandwidth UL CA combination, the at least one low uplink transmit switching time UL CA combination, or the at least one combined UL CA combination to determine a predicted UL CA combination. This step 204 can be determined in a variety of ways. Turning briefly now to FIG. 3, illustrated therein is one example. Others will be obvious to those of ordinary skill in the art having the benefit of this disclosure.

As shown in FIG. 3, step 204 is triggered by the foreground application to be initiated for operation on the one or more processors (109) or actually operating on the one or more processors (109) is identified at step 301. From this information, in one or more embodiments step 302 comprises ranking, by the one or more processors (109), the plurality of UL CA combinations supported by the communication device (118) of the electronic device (100) based upon a throughput score associated with each UL CA combination, a latency score associated with each UL CA combination, and a combined throughput and latency score associated with each UL CA combination.

In one or more embodiments, this ranking occurring at step 302 results in a first UL CA combination having a lower uplink transmit switching time receiving a higher latency score than a second UL CA combination having a higher uplink transmit switching time. In one or more embodiments, the ranking results in a first UL CA combination having a larger bandwidth associated therewith receiving a higher throughput score than a second UL CA combination having a smaller bandwidth associated therewith. In one or more embodiments, wherein the combined throughput and latency score associated with the ranking comprises a sum of the throughput score and the latency score.

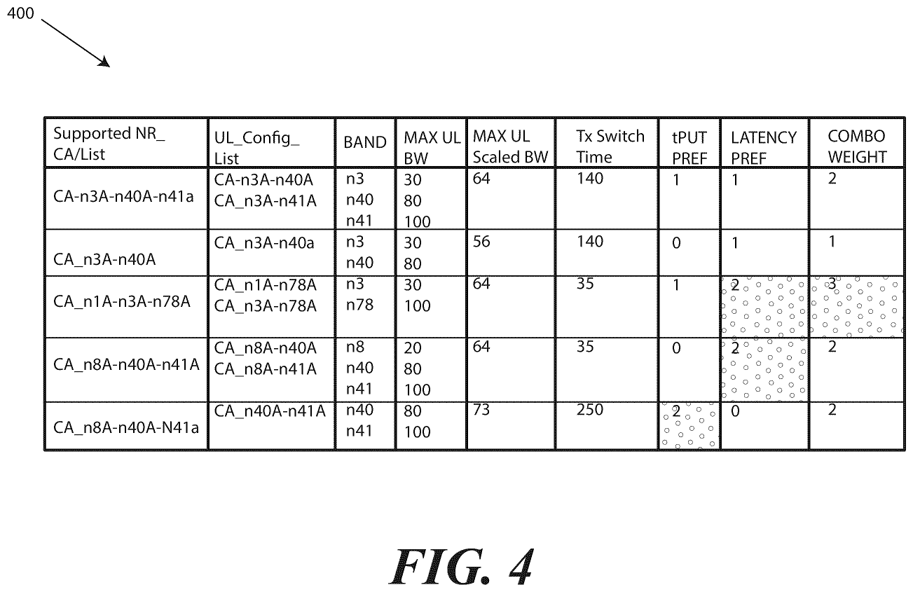

To see these elements in more detail, turn briefly now to FIG. 4 where a table 400 of UL CA combinations supported by an electronic device is shown. As shown in this table, each UL CA combination is show with its maximum uplink bandwidth, its maximum uplink scaled bandwidth, and its transmit switching time. In the three columns on the right side of the table 400, the plurality of UL CA combinations supported by the communication device of the electronic device have been ranked based upon a throughput score associated with each UL CA combination (the third column from the right), a latency score associated with each UL CA combination (the second column from the right), and a combined throughput and latency score associated with each UL CA combination (the right most column).

In FIG. 4, higher scores are preferable for a particular factor. Thus, a score of three in the combined column where a sum of the throughput score and the latency score forms a combined throughput and latency score is better than a score of one. As shown in FIG. 4, one or more processors of the electronic device have assigned a bandwidth score to a plurality of UL CA combinations supported by a communication device of the electronic device, a latency score to the plurality of UL CA combinations, and have combined the bandwidth score and the latency score of each UL CA combination of the plurality of UL CA combinations. The preferred UL CA combinations for each class are shown with bubbled in backgrounds.

Turning now back to FIG. 3, at decision 303 and decision 304 predict whether the foreground application to be initiated for operation on the one or more processors (109) will be better optimized when served by a high bandwidth UL CA combination, a low uplink transmit switching time UL CA combination, or a combined UL CA combination. To wit, decision 303 determines whether the foreground application is latency intensive. Where it is, step 306 selects at least one low uplink transmit switching time UL CA combination. Decision 304 determines whether the foreground application is throughput sensitive. Where it is, step 307 selects at least one high bandwidth UL CA combination. Where decision 303 and decision 304 determines both are preferred, step 305 selects the combined UL CA combination.

Turning now back to FIG. 2, at step 205 the method 200 builds a UCI message (138). In one or more embodiments, the UCI message (138) comprises fewer UL CA combinations than are in the plurality of UL CA combinations that are supported by the electronic device (100). Moreover, in one or more embodiments the UCI message (138) comprises the predicted UL CA combination.

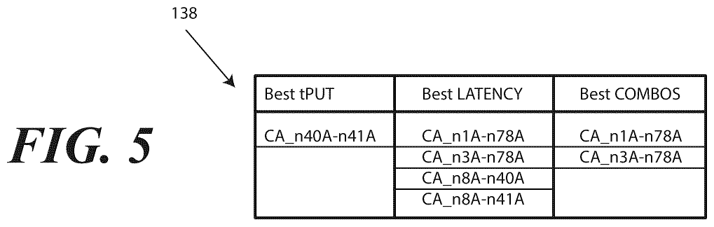

Turning briefly to FIG. 5, illustrated therein is one such UCI message. As shown, it includes three columns, each identifying the best throughput UL CA combination, the best latency UL CA combination, and the best combined UL CA combination. By comparing FIG. 4 with FIG. 5, it can be seen that this illustrative UCI message 138 comprises fewer UL CA combinations than are in the plurality of UL CA combinations that are supported by the electronic device (100) shown in the table of FIG. 4 and comprises the predicted UL CA combination, which would be the best latency column for our friend, Armin, while trading options.

Turning now back to FIG. 2, decision 206 determines whether it is appropriate for the UCI message (138) to be transmitted. Where it is, step 207 comprises causing the communication device (118) to transmit the predicted UL CA combination. In one or more embodiments, step 207 comprises causing the communication device (118) to transmit the UCI message (138).

As noted above, in one or more embodiments step 207 occurs in response to a hardware capability of the communication device changing. To ensure the network is not overloaded with UCI messages, in one or more embodiments step 207 comprises initiating, by the one or more processors (109), a timer, and precluding, by the one or more processors (109), the communication device (118) from transmitting another predicted UL CA combination until the timer expires.

Accordingly, the method 200 of FIG. 2 has selected one of at least one UL CA combination having a high bandwidth score, at least one UL CA combination having a low latency score, or at least one UL CA combination having a combined bandwidth and latency score indicating high bandwidth and low latency as a function of the predicted application as a selected UL CA combination at step 204. Additionally, the method 200 has caused the communication device (118) to transmit the UCI message (138) identifying the selected UL CA combination across a network (126) to a remote electronic device (137).

Returning to our friend, Armin, by dynamically adapting to Armin's needs, the method 200 not only enhances his trading performance but also ensures that he remains competitive in the fast-paced world of options trading. The ability to predict and allocate the necessary bandwidth before Armin even launches his application demonstrates the advanced capabilities of the method 200, offering him peace of mind and the confidence that his trades will be executed without delay. This intelligent adaptation to user behavior exemplifies the innovative approach to optimizing application performance based on UL CA and transmit switching times, ensuring that users like Armin can rely on their devices for tasks.

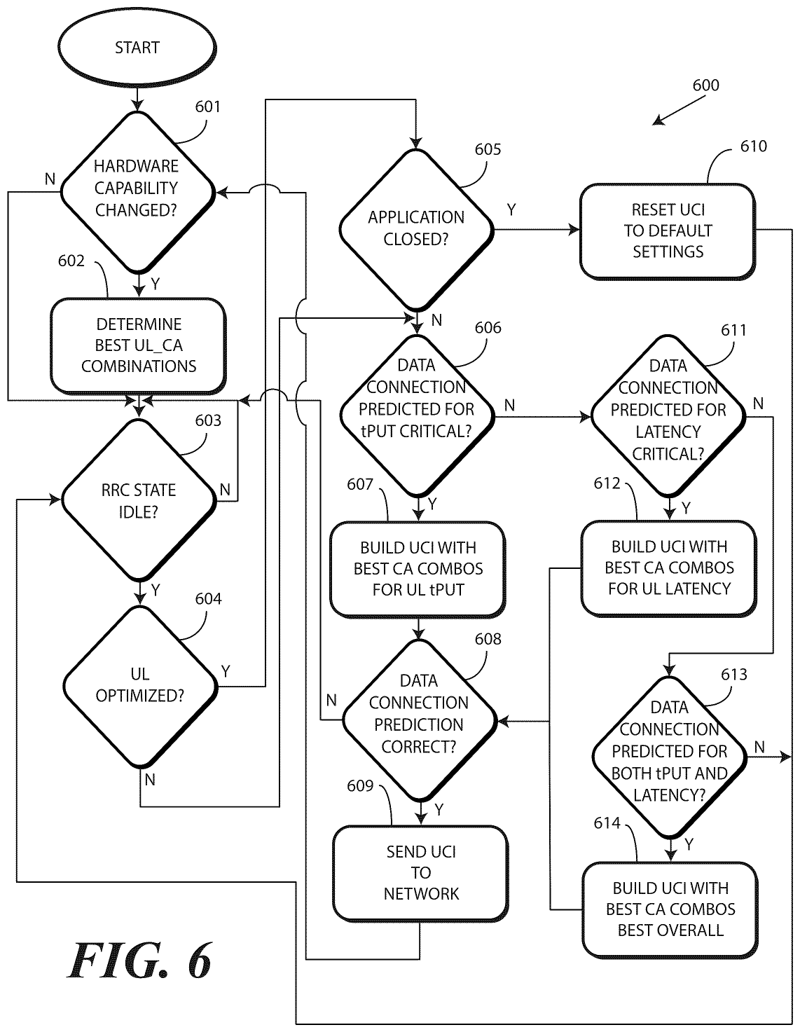

Turning now to FIG. 6, illustrated therein is another explanatory method 600 in accordance with one or more embodiments of the disclosure. FIG. 6 shows an embodiment of a method 600 for dynamically selecting the optimal UL CA combination based on predicted application requirements. The method 600 can be implemented by an electronic device with MIMO and CA communication modes of operation.

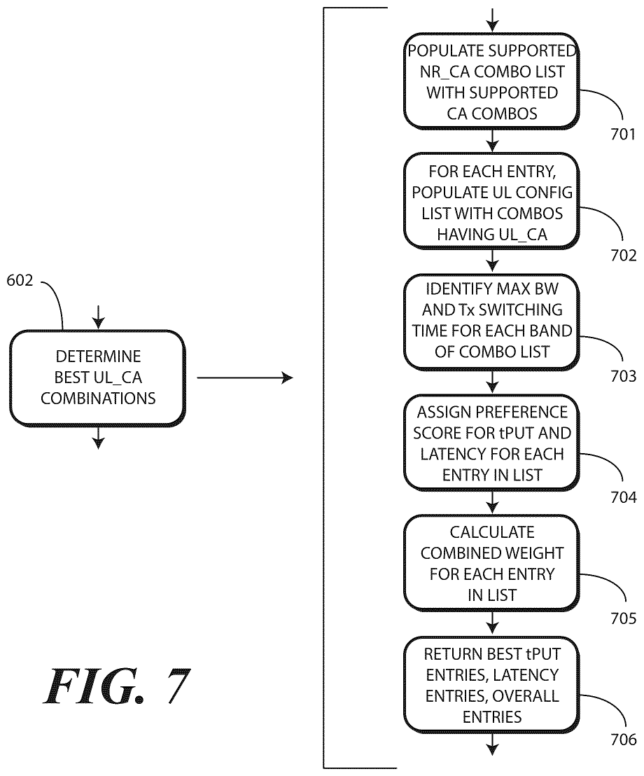

At decision 601, the method 600 determines whether the hardware capability of the electronic device has changed. If the hardware capability has changed, the method proceeds to step 602 to determine the UL CA combinations. Step 602 can be performed in a variety of ways. Turning now briefly to FIG. 7, illustrated therein is one technique for performing step 602. Others will be obvious to those of ordinary skill in the art having the benefit of this disclosure.

FIG. 7 shows one or more method steps for determining the UL CA combinations that are optimal for the foreground application at step 602. The method steps can be implemented by an electronic device with MIMO and CA communication modes of operation.

At step 701, the method populates a supported UL CA combination list (similar to the table (400) of FIG. 4) with a plurality of UL CA combinations supported by an electronic device. In one or more embodiments, this step 701 involves identifying all the UL CA combinations that the electronic device supports and listing them in a comprehensive manner.

At step 702, for each entry in the supported UL CA combination list, the method steps populate a UL config list with combinations having a corresponding uplink CA. This step 702 ensures that the UL CA combination list includes only those combinations that support uplink carrier aggregation.

At step 703, the method identifies the maximum bandwidth (BW) and transmit (Tx) switching time for each band of the UL CA combination list. In one or more embodiments, this step 703 involves determining the possible bandwidth and the time required to switch transmission paths for each band in the list.

At step 704, the method assigns a preference score for throughput (tPUT) and latency for each entry in the UL CA combination list. In one or more embodiments, this step 704 involves evaluating each combination based on the combination's throughput and latency performance and assigning a score accordingly.

At step 705, the method calculates a combined weight for each entry in the UL CA combination list. In one or more embodiments, this step 705 involves combining the throughput and latency scores to generate a comprehensive performance metric for each combination.

At step 706, the method returns the throughput entries, latency entries, and overall entries. In one or more embodiments, this step 706 involves selecting the top-performing combinations based on throughput, latency, and a combination of both, and presenting them as the optimal choices for the electronic device. The results of the method steps of FIG. 7 are shown generally in FIGS. 4-5, as previously described.

Turning now back to FIG. 6, in one or more embodiments if the hardware capability has not changed, the method proceeds to decision 603. At decision 603, the method 600 checks whether the RRC state of the communication device is in RRC IDLE state. If the RRC state is not idle, the method 600 returns to decision 601. If the RRC state is idle, the method 600 proceeds to decision 604.

At decision 604, the method 600 checks whether the uplink is optimized. If the UL is not optimized, the method 600 returns to decision 606. If the UL is optimized, the method 600 proceeds to decision 605.

At decision 605, the method 600 checks whether the application has been closed. In one or more embodiments. If the application has been closed, the method 600 proceeds to step 610 to reset the UCI to default settings. Said differently, in one or more embodiments step 610 comprises resetting the UCI message to include the plurality of UL CA combinations in response to cessation of operation of the foreground application on the one or more processors. If the application has not been closed, the method 600 proceeds to decision 606.

At decision 606, the method 600 checks whether the data connection is predicted to be throughput sensitive to optimize operation of the foreground application. If the data connection is predicted to be throughput sensitive to optimize operation of the foreground application, the method 600 proceeds to step 607 to build the UCI message with the optimal UL CA combinations for throughput performance. If the data connection is not predicted to be throughput sensitive to optimize operation of the foreground application, the method 600 proceeds to decision 611.

At decision 611, the method 600 checks whether the data connection is predicted to be latency sensitive to optimize operation of the foreground application. If the data connection is predicted to be latency sensitive to optimize operation of the foreground application, the method 600 proceeds to step 612 to build the UCI message with the optimal CA combinations for uplink latency performance. If the data connection is not predicted to be latency sensitive to optimize operation of the foreground application, the method 600 proceeds to decision 613.

At decision 613, the method 600 checks whether the data connection is predicted to be necessary for both throughput and latency sensitivity to optimize operation of the foreground application. If the data connection is predicted to be necessary for both throughput and latency sensitivity to optimize operation of the foreground application, the method 600 proceeds to step 614 to build the UCI message with the best UL CA combinations having the highest combined scores overall. If the data connection is not predicted to be necessary for both throughput and latency sensitivity to optimize operation of the foreground application, the method 600 returns to decision 601.

At decision 608, the method 600 checks whether the data connection prediction is correct. If the data connection prediction is correct, the method 600 proceeds to step 609 to send the UCI message to the network. If the data connection prediction is not correct, the method 600 returns to decision 601 so that the process can repeat.

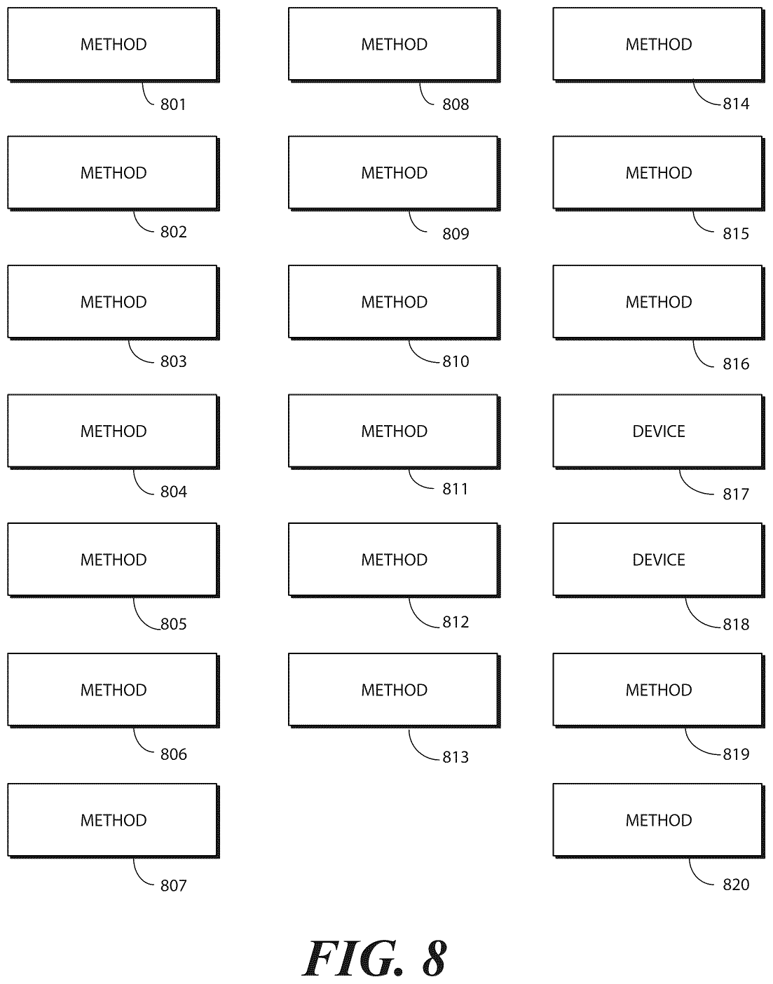

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises selecting, by one or more processors from a plurality of uplink carrier aggregation (UL CA) combinations supported by a communication device of the electronic device having multiple input and multiple output (MIMO) and carrier aggregation (CA) communication modes of operation, at least one high bandwidth UL CA combination, at least one low uplink transmit switching time UL CA combination, and at least one combined UL CA combination having a higher bandwidth and a lower uplink transmit switching time associated therewith than at least one other UL CA combination of the plurality of UL CA combinations. At 801, the method comprises predicting, by the one or more processors, whether a foreground application to be initiated for operation on the one or more processors will be better optimized when served by the at least one high bandwidth UL CA combination, the at least one low uplink transmit switching time UL CA combination, or the at least one combined UL CA combination to determine a predicted UL CA combination. At 801, the method comprises causing, by the one or more processors, the communication device to transmit the predicted UL CA combination to a remote electronic device of a network serving the communication device of the electronic device.

At 802, a higher bandwidth UL CA combination of 801 results in higher throughput data communication available to the foreground application. At 802, a lower uplink transmit switching time CA combination results in lower data latency data communication available to the foreground application.

At 803, the method of 801 further comprises ranking, by the one or more processors, the plurality of UL CA combinations supported by the communication device of the electronic device based upon a throughput score associated with each UL CA combination, a latency score associated with each UL CA combination, and a combined throughput and latency score associated with each UL CA combination. At 804, the ranking of 803 results in a first UL CA combination having a lower uplink transmit switching time receiving a higher latency score than a second UL CA combination having a higher uplink transmit switching time.

At 805, the ranking of 803 results in a first UL CA combination having a larger bandwidth associated therewith receiving a higher throughput score than a second UL CA combination having a smaller bandwidth associated therewith. At 806, the combined throughput and latency score of 803 comprises a sum of the throughput score and the latency score. At 807, the transmitting of 801 occurs when a radio resource control (RRC) state of the communication device is in RRC IDLE state and in response to the foreground application being initiated.

At 808, the method of 801 further comprises also predicting, by the one or more processors, the foreground application to be initiated for operation on the one or more processors. At 809, the predicting the foreground application to be initiated for operation on the one or more processors of 808 comprises monitoring, by one or more sensors, user interactions with the electronic device.

At 810, the predicting the foreground application to be initiated for operation on the one or more processors of 808 comprises assessing, by the one or more processors, a log of previous foreground application operation initiations on the one or more processors. At the predicting the foreground application to be initiated for operation on the one or more processors of 810 further comprises assessing one or more of a time of day, calendar events stored within a calendaring application operating on the one or more processors, and/or a location of the electronic device as determined by a location detector operable with the one or more processors.

At 812, the method of 801 further comprises building a user equipment capability information (UCI) message comprising fewer UL CA combinations than are in the plurality of UL CA combinations and the predicted UL CA combination. At 813, the causing the communication device of 812 to transmit the predicted UL CA combination comprises causing the communication device to transmit the UCI message. At 814, the method of 813 further comprises resetting the UCI message to include the plurality of UL CA combinations in response to cessation of operation of the foreground application on the one or more processors.

At 815, the causing the communication device to transmit the predicted UL CA combination at 801 occurs in response to a hardware capability of the communication device changing. At 816, the method of 801 further comprises initiating, by the one or more processors, a timer, and precluding, by the one or more processors, the communication device from transmitting another predicted UL CA combination until the timer expires.

At 817, an electronic device comprises a communication device supporting a plurality of uplink carrier aggregation (UL CA) combinations for multiple frequency bands of operation, one or more processors operable with the communication device, and a memory, operable with the one or more processors. At 817, the memory stores at least a first application operable on the one or more processors having a first application optimized operation when the communication device supports a high bandwidth UL CA combination, a second application operable on the one or more processors having a second application optimized operation when the communication device supports a low uplink transmit switching time UL CA combination, and a third application operable on the one or more processors having a third application optimized operation when the communication device supports a combined higher bandwidth and lower uplink transmit switching time UL CA combination than at least one other UL CA combination of the plurality of UL CA combinations.

At 817, the one or more processors predict whether the first application, the second application, or the third application will be initiated for operation. At 817, the one or more processors cause the communication device to identify the high bandwidth UL CA combination to a network in communication with the communication device when the one or more processors predict the first application will be initiated for operation on the one or more processors. At 817, the one or more processors cause the communication device to identify the low uplink transmit switching time UL CA combination to the network when the one or more processors predict the second application will be initiated for operation on the one or more processors. At 817, the one or more processors cause the communication device to identify the combined higher bandwidth and lower uplink transmit switching time UL CA combination when the third application will be initiated for operation on the one or more processors.

At 818, the one or more processors of 817 cause the communication device to identify the high bandwidth UL CA combination in response to either a communication device hardware configuration change or the communication device operating in a radio resource control (RRC) IDLE state.

At 819, a method in an electronic device comprises assigning, by one or more processors, a bandwidth score to a plurality of uplink carrier aggregation (UL CA) combinations supported by a communication device of the electronic device. At 819, the method comprises also assigning, by the one or more processors, a latency score to the plurality of UL CA combinations.

At 819, the method comprises combining, by the one or more processors, the bandwidth score and the latency score of each UL CA combination of the plurality of UL CA combinations. At 819, the method comprises predicting, by the one or more processors, a predicted application to be launched for operation on the one or more processors.

At 819, the method comprises selecting one of at least one UL CA combination having a high bandwidth score, at least one UL CA combination having a low latency score, or at least one UL CA combination having a combined bandwidth and latency score indicating high bandwidth and low latency as a function of the predicted application as a selected UL CA combination. At 819, the method comprises causing, by the one or more processors, the communication device to transmit a user equipment capability information (UCI) message identifying the selected UL CA combination across a network to a remote electronic device. At 820, the UCI message of 819 omits at least some UL CA combinations from the plurality of UL CA combinations.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
selecting, by one or more processors from a plurality of uplink carrier aggregation (UL CA) combinations supported by a communication device of the electronic device having multiple input and multiple output (MIMO) and carrier aggregation (CA) communication modes of operation:
at least one high bandwidth UL CA combination;
at least one low uplink transmit switching time UL CA combination; and
at least one combined UL CA combination having a higher bandwidth and a lower uplink transmit switching time associated therewith than at least one other UL CA combination of the plurality of UL CA combinations;
predicting, by the one or more processors, whether a foreground application to be initiated for operation on the one or more processors will be better optimized when served by:
the at least one high bandwidth UL CA combination;
the at least one low uplink transmit switching time UL CA combination; or
the at least one combined UL CA combination;
to determine a predicted UL CA combination; and
causing, by the one or more processors, the communication device to transmit the predicted UL CA combination to a remote electronic device of a network serving the communication device of the electronic device.

2. The method of claim 1, wherein:
a higher bandwidth UL CA combination results in higher throughput data communication available to the foreground application; and
a lower uplink transmit switching time CA combination results in lower data latency data communication available to the foreground application.

3. The method of claim 1, further comprising ranking, by the one or more processors, the plurality of UL CA combinations supported by the communication device of the electronic device based upon a throughput score associated with each UL CA combination, a latency score associated with each UL CA combination, and a combined throughput and latency score associated with each UL CA combination.

4. The method of claim 3, wherein the ranking results in a first UL CA combination having a lower uplink transmit switching time receiving a higher latency score than a second UL CA combination having a higher uplink transmit switching time.

5. The method of claim 3, wherein the ranking results in a first UL CA combination having a larger bandwidth associated therewith receiving a higher throughput score than a second UL CA combination having a smaller bandwidth associated therewith.

6. The method of claim 3, wherein the combined throughput and latency score comprises a sum of the throughput score and the latency score.

7. The method of claim 1, wherein the transmitting occurs when a radio resource control (RRC) state of the communication device is in RRC IDLE state and in response to the foreground application being initiated.

8. The method of claim 1, further comprising also predicting, by the one or more processors, the foreground application to be initiated for operation on the one or more processors.

9. The method of claim 8, wherein the predicting the foreground application to be initiated for operation on the one or more processors comprises monitoring, by one or more sensors, user interactions with the electronic device.

10. The method of claim 8, wherein the predicting the foreground application to be initiated for operation on the one or more processors comprises assessing, by the one or more processors, a log of previous foreground application operation initiations on the one or more processors.

11. The method of claim 10, wherein the predicting the foreground application to be initiated for operation on the one or more processors further comprises assessing one or more of a time of day, calendar events stored within a calendaring application operating on the one or more processors, and/or a location of the electronic device as determined by a location detector operable with the one or more processors.

12. The method of claim 1, further comprising building a user equipment capability information (UCI) message comprising:
fewer UL CA combinations than are in the plurality of UL CA combinations; and
the predicted UL CA combination.

13. The method of claim 12, wherein the causing the communication device to transmit the predicted UL CA combination comprises causing the communication device to transmit the UCI message.

14. The method of claim 13, further comprising resetting the UCI message to include the plurality of UL CA combinations in response to cessation of operation of the foreground application on the one or more processors.

15. The method of claim 1, wherein the causing the communication device to transmit the predicted UL CA combination occurs in response to a hardware capability of the communication device changing.

16. The method of claim 1, further comprising initiating, by the one or more processors, a timer, and precluding, by the one or more processors, the communication device from transmitting another predicted UL CA combination until the timer expires.

17. An electronic device, comprising:
a communication device supporting a plurality of uplink carrier aggregation (UL CA) combinations for multiple frequency bands of operation;
one or more processors operable with the communication device; and
a memory, operable with the one or more processors, and storing at least:
a first application operable on the one or more processors having a first application optimized operation when the communication device supports a high bandwidth UL CA combination;
a second application operable on the one or more processors having a second application optimized operation when the communication device supports a low uplink transmit switching time UL CA combination; and
a third application operable on the one or more processors having a third application optimized operation when the communication device supports a combined higher bandwidth and lower uplink transmit switching time UL CA combination than at least one other UL CA combination of the plurality of UL CA combinations;
wherein the one or more processors predict whether the first application, the second application, or the third application will be initiated for operation and cause the communication device to:
identify the high bandwidth UL CA combination to a network in communication with the communication device when the one or more processors predict the first application will be initiated for operation on the one or more processors;
identify the low uplink transmit switching time UL CA combination to the network when the one or more processors predict the second application will be initiated for operation on the one or more processors; and
identify the combined higher bandwidth and lower uplink transmit switching time UL CA combination when the third application will be initiated for operation on the one or more processors.

18. The electronic device of claim 17, wherein the one or more processors cause the communication device to identify the high bandwidth UL CA combination in response to either a communication device hardware configuration change or the communication device operating in a radio resource control (RRC) IDLE state.

19. A method in an electronic device, the method comprising:
assigning, by one or more processors, a bandwidth score to a plurality of uplink carrier aggregation (UL CA) combinations supported by a communication device of the electronic device;
also assigning, by the one or more processors, a latency score to the plurality of UL CA combinations;
combining, by the one or more processors, the bandwidth score and the latency score of each UL CA combination of the plurality of UL CA combinations;
predicting, by the one or more processors, a predicted application to be launched for operation on the one or more processors;
selecting one of at least one UL CA combination having a high bandwidth score, at least one UL CA combination having a low latency score, or at least one UL CA combination having a combined bandwidth and latency score indicating high bandwidth and low latency as a function of the predicted application as a selected UL CA combination; and
causing, by the one or more processors, the communication device to transmit a user equipment capability information (UCI) message identifying the selected UL CA combination across a network to a remote electronic device.

20. The method of claim 19, wherein the UCI message omits at least some UL CA combinations from the plurality of UL CA combinations.
